(19) United States
(12) Patent Application Publication
(10) Pub. No.: US 2022/0225829 A1
(43) Pub. Date: Jul. 21, 2022

(54) STACKABLE, RECHARGEABLE DISH WARMING SYSTEM AND ASSEMBLY

(71) Applicant: Dale Paulsen, Manchester, IA (US)

(72) Inventor: Dale Paulsen, Manchester, IA (US)

(21) Appl. No.: 17/151,440

(22) Filed: Jan. 18, 2021

(51) Int. Cl. A47J 39/02; H05B 1/02; H02J 7/02; H02J 50/90; H02J 50/40

(52) U.S. Cl. CPC A47J 39/025; H05B 1/0252; H02J 50/40; H02J 7/02; H02J 50/90; H05B 1/0202

(57) ABSTRACT

The present invention relates to a dish warming system that includes a plurality of dish warming assemblies each having a plate with a power source and a heat element. The power source of each dish warming assembly allows for the concurrent charging of the plurality of dish warming assemblies while stacked. The heat element in some iterations of the system includes a pressure switch that activates the heat element when a dish is placed on the dish warming assembly.

### BACKGROUND OF THE INVENTION

This invention is directed towards a dish warming system and assembly. More specifically, and without limitation, this invention relates to a stackable, rechargeable dish warming system and assembly configured to maintain a warm temperature of cooked or heated foods.

Various methods are known to maintain the temperature of cooked or heated food. For example, it is known to place aluminum foil over dishes to contain the heat of the food therein. However, aluminum is a poor insulator and provides limited advantage in maintaining the warmth of food.

Various bags and enclosures have been developed to increase the amount of insulation provided. Each of these enclosures, including the general use of aluminum foil fails, prevents the consumption of the food.

Additionally, the use of such devices is not aesthetically pleasing and has limited usefulness in a restaurant setting where dishes are often placed on a shelf for delivery to a patron visiting the restaurant who may not immediately eat the food due to engaging conversation or waiting for an accompanying patron to receive their food, which is viewed as polite.

Thus it is a primary objective of this invention to provide a dish warming assembly and system that improves upon the art.

Another objective of this invention is to provide a dish warming assembly and system that keeps food warm when uncovered.

Yet another objective of this invention is to provide a dish warming assembly and system that is stackable.

Another objective of this invention is to provide a dish warming assembly and system that is rechargeable.

Yet another objective of this invention is to provide a dish warming assembly and system that is operational while being mobile.

Another objective of this invention is to provide a dish warming assembly and system that is easy to use and user friendly.

Yet another objective of this invention is to provide a dish warming assembly and system that is safe.

These and other objectives, features, and advantages of the invention will become apparent from the specification and claims.

### SUMMARY OF THE INVENTION

In general, the present invention relates to a dish warming system and assembly. The dish warming system includes at least one dish warming assembly that is configured to receive a dish on a plate of the dish warming assembly. Upon placement of the dish, an activation switch is activated turning on a heat element that maintains a warm temperature of the food on the dish.

To recharge, a recharging unit is attached to a power source of the dish warming assembly. In some embodiments of the present system, multiple dish warming assemblies are included that are stackable. When stacked, the multiple dish warming assemblies are rechargeable with a single connection to a recharging unit. This is accomplished by charging contacts on the power source of each dish warming assembly that are in electrical communication such that the electricity from the recharging unit received by one dish warming assembly is passed to a second, third, fourth, (etc.) dish warming assembly.

In certain arrangements of the present invention, a bottom surface of the plate of the dish warming assembly has one or more protrusion, a recess, or both that are configured to prevent the activation of the activation switch, which would otherwise occur upon stacking the dish warming assemblies.

### BRIEF DESCRIPTION OF THE DRAWINGS

FIG. 1 is a perspective view of a dish warming system;

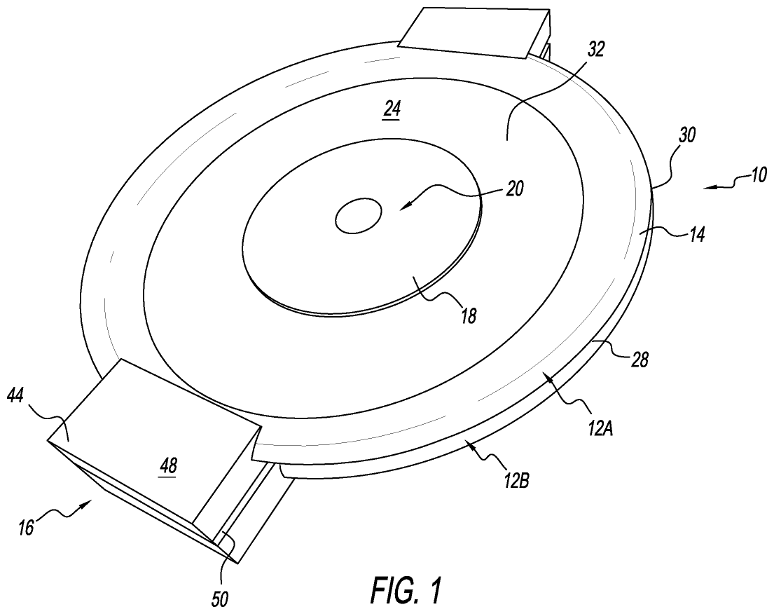

FIG. 2 is a top view of a dish warming assembly;

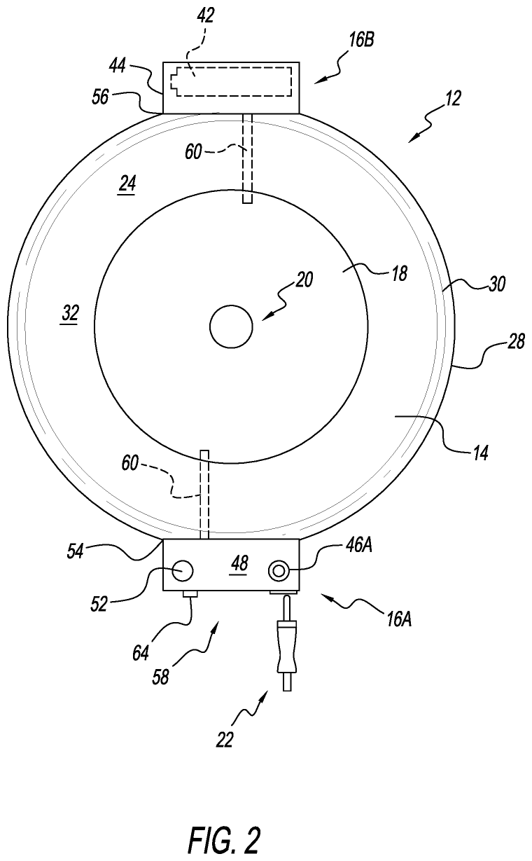

FIG. 3 is a side cut-away view of a dish warming assembly;

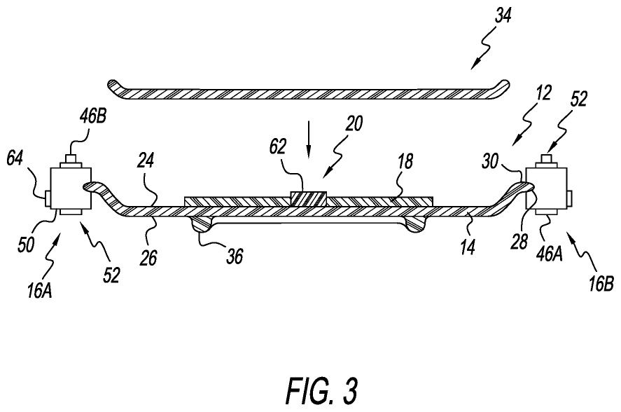

FIG. 4 is a top view of a dish warming assembly; and

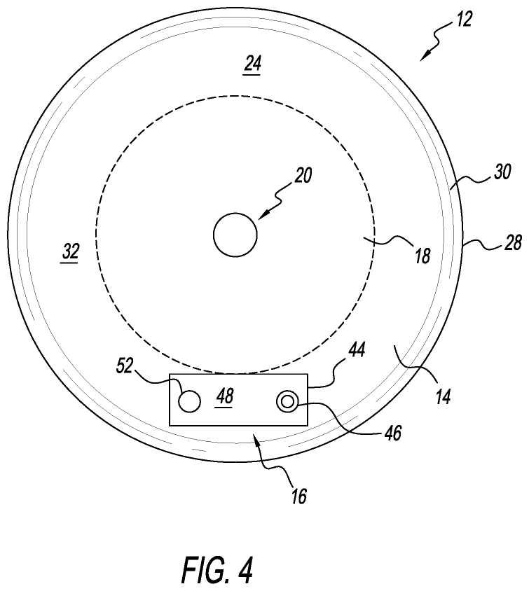

FIG. 5 is a side cut-away view of a dish warming assembly.

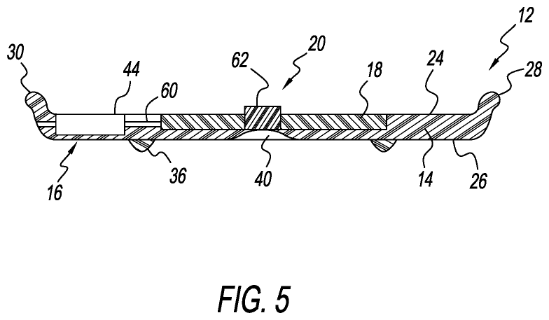

### DETAILED DESCRIPTION

With reference to the figures a dish warming system 10 is shown having a dish warming assembly 12 having a plate or tray 14, one or more power sources 16, a heat element 18, an activation switch 20, and a recharging unit 22. In some embodiments of the present invention, dish warming system 10 is configured to stack multiple dish warming assemblies 12 on top of each other while recharging, such as a first dish warming assembly 12A and a second dish warming assembly 12B.

In some iterations of the present invention, the plate 14 has a top surface 24 and a bottom surface 26 with at least one side wall or edge 28 positioned between the top surface 24 and the bottom surface 26. For instance, in embodiments in which the plate 14 is circular, the side wall or edge 28 would extend around the circumference of the plate 14. In some embodiments, the plate 14 is shaped such that a lip 30 is formed such that the top surface 24 and bottom surface 26 are elevated adjacent the side wall 28 in relation to a central portion 32 of the plate 14. In such a configuration, the lip 30 facilitates stacking of multiple dish warming assemblies 12 as the central portion 32 of each dish warming assembly is restricted from moving laterally. The presence of the lip 30 in some embodiments further provides the advantage of maintaining the position of a dish 34 (such as a dish plate, bowl, saucer, cup, mug, and the like) (not shown) placed on the top surface 24 of the plate 14.

In some arrangements of the present invention the bottom surface 26 of the plate 14 has at least one protrusion 36 that extends away from the top surface 24 and the bottom surface 26 of the plate 14. For instance, the protrusion 36 in some embodiments is shaped as a circle that generally encircles the central portion 32 of the plate 14. In other embodiments, multiple protrusions 36 can extend from the bottom surface 26 such that the protrusions 36 provide a stable contact with a surface such as a table 38 (not shown) thereby preventing or limiting the dish warming assembly from wobbling during use.

In addition or alternatively, the bottom surface 26 has a recess 40 such that the shape of the bottom surface 26 extends upwards towards the top surface 24—in this way the thickness of the plate 14 is less than the thickness of the remainder of the central portion 32 of the plate 14. In some embodiments, the recess 40 has a dome shape and in others a cylindrical shape. The configuration of the recess 40, as well as the at least one protrusion 36 in various arrangements, enhances the safety and recharging of the dish warming system 10 as disclosed in further detail below.

In some embodiments of the present invention, the power source 16 includes one or more rechargeable batteries 42 contained within a housing 44. In some embodiments, the housing 44 includes at least one charging contact 46 that is attached to a top wall 48 and a bottom opposing 50 of the housing 44. The charging contact 46 is configured to pass electrical current between power sources 16 of multiple dish warming assemblies 12 such that charging can occur when multiple dish warming assemblies 12 are stacked upon each other. In some arrangements, one or more magnet 52 is connected to the housing 44 to provide for a magnetic connection between the housing 44 of multiple dish warming assemblies when stacked. In some embodiments, the charging contacts 46 are one or more set of mating male connection member 46A, such as prongs, and female connection members 46B, such as input jacks.

As shown in the illustrative embodiments, the housing 44 is positioned to the exterior of the plate 14. In particular arrangements, a first power source 16A is attached to a first side 54 of the side wall 28 of the plate 14 and a second power source 16B is attached to a second opposing side 56 of the side wall 28 of the plate. This configuration permits the housing 44 of the first power source 16A and second power source 16B to function as handles 58. Such a configuration also limits the likelihood that food, such as a soup, will come into contact with the charging contacts 46 that could impeded charging. In other embodiments, the power source 16 is contained within the plate 14 rather than the housing 44.

The one or more power source 16 is in electrical communication with the heat element 18, such as by way of wiring 60. The heat element 18, in some embodiments, is attached to the top surface 24 of the plate 14 such that the heat element 18 is not enclosed by the plate 14 but rather exposed for direct contact with the dish 34. In other embodiments, the heat element 18 is positioned entirely within the plate 14 such that direct contact with heat element 18 is prevented by the plate 14. While useful, positioning the heat element 18 within the plate 14 will result in some of the heat from the heat element 18 dissipating or dispersing through the plate 14 thereby providing less direct heating to the dish 34. In particular arrangements, the heat element 18 is circular and is smaller than the central portion 32 of the plate 14, which permits foods that do not need to have a warm temperature to be positioned on the dish 34 in a position outside of occupancy of the heat element 18 to limit the warming effect of the heat element 18.

In some embodiments, the heat element 18 is configured to produce a predefined temperature. In some arrangements, the predefined temperature is 115° F., which provides the unique advantage of keeping food warm without cooking high price items, such as steak that at internal temperatures above 115° F. increases the doneness of the steak beyond what some patrons may prefer. The use of a static, predefined temperature also provides the advantage of making the dish warming assembly 12 easy to use and avoids the potential for the temperature to be set incorrectly. In other embodiments, the heat element 18 is configured to produce a range of selectable, definable temperatures.

Connected to and in communication with the heat element 18 is the activation switch 20. As seen in the illustrative embodiments, the activation switch 20 is configured to activate upon the application of pressure. In some such arrangements, the activation switch 20 has a button, pressure plate, or pressure switch 62 that protrudes from the top surface 24 of the plate 14. In such embodiments, the placement of the dish 34 on the top surface 24 engages and presses the pressure switch 62 thereby activating the heat element 18. Upon removal of the dish 34, the pressure switch is released and the heat element is deactivated.

In some embodiments of the present invention that include the bottom surface 26 having one or more protrusion 36, the one or more protrusion 36 is configured to elevate the bottom surface 26 of the first dish assembly 12A above the top surface 24 of the second dish assembly 12B when the first dish assembly 12A is stacked atop the second dish assembly 12B, thereby preventing the activation of the activation switch 20 through engagement between the dish warming assemblies 12. Additionally or alternatively, some arrangements of the dish warming system 10 having the recess 40 in the bottom surface 26 of the first dish warming assembly 12A prevents engagement with the activation switch 20 of the second dish warming assembly 12B when the first dish warming assembly 12A is stacked on the second dish warming assembly 12B. In these ways, the dish warming assembly 10 prevents activation of the heat element 18 when multiple dish warming assemblies 12 are stacked upon each other, which could pose a safety risk and prevent or limit recharging efficiencies.

Alternatively or in addition to such arrangements, some embodiments of the present invention have an activation toggle 64 that toggles between a fixed ON position and a fixed OFF position that is not determined by pressure being applied to the activation toggle 64. The presence of an activation toggle 64 limits accidental activation of the heat element 18.

The power sources 16 described herein are configured to electrically connect to the recharging unit 22. In some embodiments, the recharging unit 22 is an AC adapter that is inserted and connects to the power source 16, which in turn charges each dish warming assembly 12 in the stack of dish warming assemblies 12. In other embodiments, the recharging unit 12 is configured to provide wireless charging to the dish warming assembly 12 positioned in immediate alignment with the recharging unit 12, which in turn charges each dish warming assembly in the stack of dish warming assemblies 12.

In operation, the dish 34 is placed on the top surface 24 of the first dish warming assembly 12A. Upon placement of the dish 34, the activation switch 20 is triggered and the heat element 18 is activated. As long as the dish 34 remains on the top surface 24, the heat element 18 will continuously warm any food placed on the dish 34.

When the food is consumed, the dish 34 is removed from the first dish warming assembly 12A and the heat element 18 is deactivated. If an insufficient amount of power is left in the power source 16, the recharging unit 22 is connected to the power source 16. If the second dish warming assembly 12B needs to be charged, the second dish warming assembly 12B is placed atop the first dish warming assembly 12A and the contact or connection between the power sources 16 of the respective dish warming assemblies 12 provides an electrical charge to the second dish warming assembly 12B that is passed from the recharging unit 22 and through the power source 16 of the first dish warming assembly 12A and into the power source 16 of the second dish warming assembly.

The presence of the protrusion 36, the recess 40, or both prevents activation of the activation switch 20, which prevents a stack of dish warming assemblies 12 from causing a safety issue. Likewise, charging is facilitated as the respective heat elements 18 remain deactivated when multiple dish warming assemblies 12 are stacked.

Therefore, a dish warming assembly 10 has been provided that maintains food warmth when not covered, is stackable, rechargeable, operational while being mobile, easy to use, user friendly, safe, and improves upon the art.

From the above discussion and accompanying figures and claims it will be appreciated that the dish warming system 10 offers many advantages over the prior art. It will be appreciated further by those skilled in the art that various other modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A dish warming system comprising:
a first dish warming assembly having a first plate, a first power source, a first heat element, and an first activation switch;
a second dish warming assembly having a second plate, a second power source, a second heat element, and a second activation switch; and
wherein when the first dish warming assembly is placed atop the second dish warming assembly a first charging contact on the first power source of the first plate aligns with a second charging contact of the second power source of the second plate such that the power sources are in electrical communication.

2. The dish warming system of claim 1 wherein the first activation switch is a pressure switch.

3. The dish warming system of claim 1 wherein the first plate has a lip.

4. The dish warming system of claim 1 further comprising a bottom surface of the first plate having a protrusion extending from the bottom surface, wherein the protrusion is configured to prevent engagement between the first dish warming assembly and the second activation switch of the second dish warming assembly.

5. The dish warming system of claim 1 further comprising a bottom surface of the first plate having a recess, wherein the recess is configured to prevent engagement between the first dish warming assembly and the second activation switch of the second dish warming assembly.

6. The dish warming system of claim 1 wherein the first power source is attached to a first side of a sidewall of the first warming assembly.

7. The dish warming system of claim 1 wherein the first heat element is not enclosed by the first plate.

8. The dish warming system of claim 1 wherein the first heat element is enclosed within the first plate.

9. The dish warming system of claim 1 wherein the first heat element is smaller than a central portion of the first plate.

10. The dish warming system of claim 1 wherein the heat element is configured to heat to a predefined temperature.

11. The dish warming system of claim 10 wherein the predefined temperature is 115° F.

12. The dish warming system of claim 1 wherein the heat element is configured to produce a range of selectable temperatures.

13. The dish warming system of claim 1 wherein the first activation switch is a pressure switch that protrudes from a top surface of the first plate.

14. The dish warming system of claim 13 further comprising the first dish warming assembly having an activation toggle.
